(19) United States
(12) Patent Application Publication
(10) Pub. No.: US 2020/0208656 A1
(43) Pub. Date: Jul. 2, 2020

(54) FLUID CONTROL DEVICE

(71) Applicant: HORIBA STEC, Co., Ltd., Kyoto-shi (JP)

(72) Inventors: Hiroshi Horiguchi, Kyoto-shi (JP); Tadahiro Yasuda, Kyoto-shi (JP); Kazuya Imai, Kyoto-shi (JP)

(21) Appl. No.: 16/705,612

(22) Filed: Dec. 6, 2019

(30) Foreign Application Priority Data
Dec. 27, 2018 (JP) 2018-245714

(51) Int. Cl. F15B 15/14

(52) U.S. Cl. CPC F15B 15/1404; F15B 2013/041

(57) ABSTRACT

There is provided a fluid control device that enables accurate control of a fluid flowing through a flow path. This fluid control device includes a block body having an internal flow path, a resistor provided within the flow path, a first pressure sensor upstream of the resistor, a second pressure sensor downstream of the resistor, and fluid control valves that control the fluid based on detection values from the pressure sensors. The block body further has an internal housing portion forming a portion of the flow path and housing the resistor. Additionally, a downstream-side flow path downstream of the housing portion has a base end connected to a downstream-side area through which flows the fluid that has already passed through the resistor. Moreover, the second pressure sensor is connected to the downstream-side area or to a vicinity of the base end.

### TECHNICAL FIELD

The present invention relates to a fluid control device.

### TECHNICAL BACKGROUND

A device is disclosed, for example, in Patent Document 1 as a fluid control device that is used in a semiconductor manufacturing process. This fluid control device is equipped with a block body having an internal flow path through which a fluid flows, a resistor that is provided within the flow path and through which the fluid passes, a first pressure sensor that detects a pressure on an upstream side of the resistor, a second pressure sensor that detects a pressure on a downstream side of the resistor, and a fluid control valve that controls the fluid based on detection values from the first pressure sensor and the second pressure sensor.

As this type of pressure-type fluid control device, there is a fluid control device that causes the fluid flowing through the flow path to pass through the resistor so that this fluid is placed in a laminar flow state, and that takes the detection values detected by the second pressure sensor as the pressure in the locations through which the fluid in this laminar flow state is flowing, and that calculates a flow rate of the fluid flowing through the flow path based on a theoretical formula (i.e., a theoretical formula of a viscous laminar flow state) using these detection values.

However, in the above-described conventional fluid control device, the second pressure sensor is connected in a position which is at a distance from the resistor. In other words, a detection point of the second pressure sensor is set in a position which is distant from the resistor. As a result, because a fluid that has passed through the resistor and has been placed in a laminar flow state is approaching a turbulent flow state by the time it reaches the detection point, the second pressure sensor ends up detecting pressure in locations where a fluid that has changed from a laminar flow state to a state approaching a turbulent flow state is flowing. Because of this, if the flow rate is calculated based on a theoretical formula using detection values from the second pressure sensor, the problem arises that a considerable divergence arises between the actual flow rate and the calculated flow rate.

Furthermore, if the detection point of the second pressure sensor is set in a position located away from the resistor, then the problem arises that the second pressure sensor is only able to detect pressures that are affected by pressure variations in the fluid, or that are affected by pressure loss that occurs before the fluid arrives at the detection point from the resistor.

As a result, in the above-described conventional fluid control device, the problem arises that it is not possible to perform accurate control of a fluid flowing through a flow path.

### DOCUMENTS OF THE PRIOR ART

### Patent Documents

Patent Document 1 Japanese Unexamined Patent Application (JP-A) No. 2010-204937

### DISCLOSURE OF THE INVENTION

### Problems to be Solved by the Invention

Therefore, it is a principal object of the present invention to provide a fluid control device that enables accurate control of a fluid flowing through a flow path to be performed.

### Means for Solving the Problem

Namely, a fluid control device according to the present invention includes a block body having an internal flow path through which a fluid flows, a resistor that is provided within the flow path and through which the fluid passes, a first pressure sensor that detects a pressure on an upstream side of the resistor, a second pressure sensor that detects a pressure on a downstream side of the resistor, and fluid control valves that control the fluid based on detection values from the first pressure sensor and the second pressure sensor, wherein the block body further includes an internal housing portion that forms a portion of the flow path and that houses the resistor, and a downstream-side flow path which forms the downstream side of the flow path from the housing portion has a base end that is connected to a downstream-side area through which flows the fluid that has already passed through the resistor in the housing portion, and the second pressure sensor is connected to the downstream-side area of the housing portion or to a vicinity of the base end of the downstream-side flow path.

According to the above-described structure, because the second pressure sensor is connected to the downstream-side area of the housing portion or to a vicinity of the base end of the downstream-side flow path, the detection point of the second pressure sensor can be set in a position that is closer to an outflow portion where the fluid flows out from the resistor. Because of this, the second pressure sensor is able to detect a pressure in a location where the fluid is still flowing in close to a full laminar flow state immediately after having passed through the resistor. Consequently, by calculating the flow rate of the fluid flowing through the flow path based on a theoretical formula using these detection values, it is possible to reduce the divergence between the actual flow rate and the calculated flow rate. Additionally, the effects of pressure variations in the fluid, and the effects of pressure loss occurring in the downstream-side flow path on the detection values detected by the second pressure sensor are suppressed. As a result, it becomes possible to perform accurate control of a fluid using this fluid control device.

Moreover, it is also possible for the block body to additionally have an internal downstream-side connecting path that is connected to the downstream-side area of the housing portion or to the vicinity of the base end of the downstream-side flow path, and that has a smaller internal diameter than that of the downstream-side flow path, and for the second pressure sensor to be connected via the downstream-side connecting path to the downstream-side area of the housing portion or to the vicinity of the base end of the downstream-side flow path.

According to the above-described structure, because the downstream-side connecting path has a smaller internal diameter than the downstream-side flow path, it is even more difficult for the second pressure sensor to be affected by pressure variations in the fluid that flows out from the resistor. In addition, the degree of freedom when placing the second pressure sensor in the block body increases, and both the design and placement of each instrument forming the fluid control device within the block body are made easier.

Moreover, it is also possible to employ a structure in which an upstream-side flow path which forms the upstream side of the flow path from the housing portion has a distal end that is connected to an upstream-side area through which the fluid flows prior to passing through the resistor in the housing portion, and in which the first pressure sensor is connected to the upstream-side area of the housing portion or to a vicinity of the distal end of the upstream-side flow path.

According to the above-described structure, because the first pressure sensor is connected to the upstream-side area of the housing portion or to a vicinity of the distal end of the upstream-side flow path, the detection point of the first pressure sensor can be set in a position that is closer to an inflow portion where the fluid is introduced into the resistor. Because of this, the first pressure sensor is able to detect a pressure in a location where the fluid is flowing immediately before passing through the resistor, so that the effects from pressure variations in the fluid are reduced. As a result, it becomes possible to perform even more accurate control of a fluid using this fluid control device.

Moreover, it is also possible to employ a structure in which the block body additionally includes an internal upstream-side connecting path that is connected to the upstream-side area of the housing portion or to an area in the vicinity of the distal end of the upstream-side flow path, and that has a smaller internal diameter than that of the upstream-side flow path, and the first pressure sensor is connected via the upstream-side connecting path to the upstream-side area of the housing portion or to the vicinity of the distal end of the upstream-side flow path.

According to the above-described structure, because the upstream-side connecting path has a smaller internal diameter than the upstream-side flow path, it is even more difficult for the first pressure sensor to be affected by pressure variations in the fluid flowing into the resistor. In addition, the degree of freedom when placing the first pressure sensor in the block body increases, and both the design and placement of each instrument forming the fluid control device within the block body are made easier.

Moreover, in a pressure-type fluid control device, responsiveness is reduced proportionally as the internal volume of a space from a valve chamber (i.e., a valve seat surface) of the fluid control valves to the housing portion increases, or as a distance from the valve chamber (i.e., the valve seat surface) to the housing portion increases. Therefore, it is also possible to employ a structure in which the block body is a rectangular object, and the fluid control valves are disposed on a predetermined surface of the block body, and an intermediate flow path from a valve chamber of the fluid control valves to the upstream-side area of the housing portion extends in an orthogonal direction relative to a valve seat surface of the fluid control valves.

According to this type of structure, because an intermediate flow path is formed so as to be orthogonal to a valve seat surface, the length of the intermediate flow path from the valve chamber to the housing portion can be set comparatively shorter. Because of this, the internal volume of a space from the valve chamber to the housing portion can be reduced, and the distance from the valve chamber to the housing portion can also be shortened. As a result, the responsiveness of the fluid control device is improved.

Moreover, in this case, it is also possible to employ a structure in which the first pressure sensor is disposed in an opposite surface from the predetermined surface of the block body, and the upstream-side connecting path extends coaxially with the intermediate flow path.

By employing this type of structure, it is possible to reduce the internal volume of the upstream-side connecting path which impacts on the responsiveness of the fluid control device, and to shorten the length thereof.

Note that it is also possible for the intermediate flow path to specifically communicate with a portion of the upstream-side flow path and an internal flow path of the fluid control valves.

According to the fluid control device having the above-described structure, it is possible to perform accurate control of a fluid flowing through a flow path.

### BRIEF DESCRIPTION OF THE DRAWINGS

FIG. 1 is a cross-sectional view schematically showing a fluid control device according to an embodiment.

FIG. 2 is a plan view schematically showing a block body of the fluid control device according to an embodiment.

FIGS. 3(a)-3(c) are cross-sectional views schematically showing the block body of the fluid control device according to an embodiment.

FIG. 4 is an enlarged cross-sectional view schematically showing an installation state of a resistor of the fluid control device according to an embodiment.

FIG. 5 is an exploded perspective view schematically showing the resistor of the fluid control device according to an embodiment.

FIG. 6 is a partial enlarged cross-sectional view schematically showing a valve periphery of an upstream-side fluid control valve of the fluid control device according to an embodiment.

FIG. 7 is an enlarged cross-sectional view schematically showing a resistor periphery of the fluid control device according to another embodiment.

### BEST EMBODIMENTS FOR IMPLEMENTING THE INVENTION

Hereinafter, a fluid control device according to the present invention will be described based on the drawings.

A fluid control device according to the present invention is installed on a flow path that is connected to respective devices that are used in a semiconductor manufacturing process. Note that the fluid control device according to the present invention can also be used on flow paths utilized in other fields.

### First Embodiment

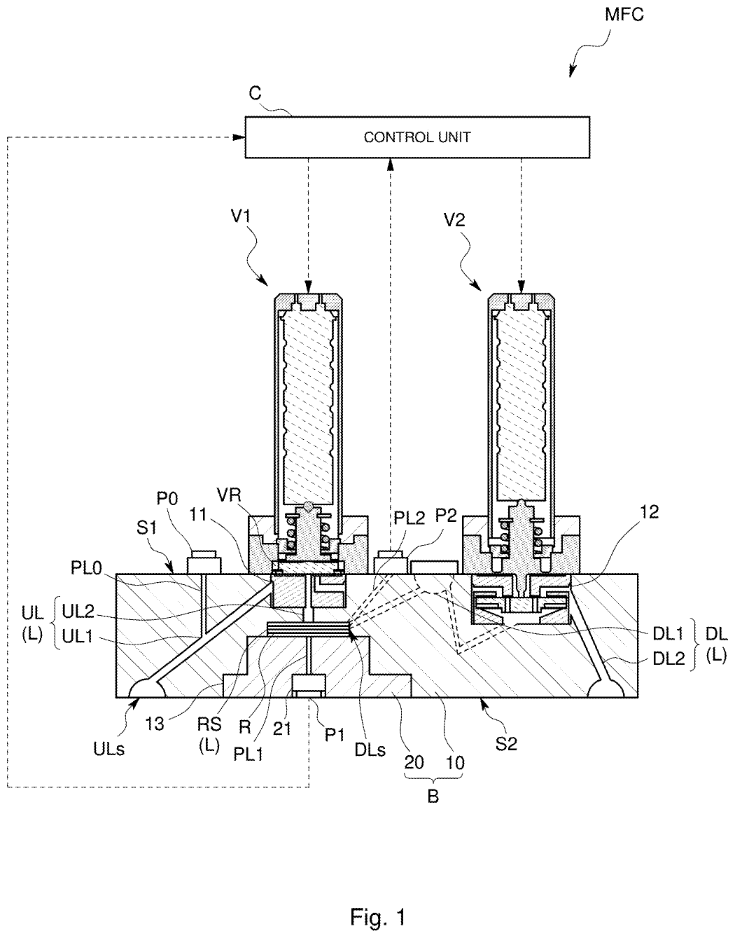

As is shown in FIG. 1, a fluid control device MFC according to the present embodiment is what is known as a pressure-type fluid control device. More specifically, the fluid control device MFC is equipped with a block body B having an internal flow path L through which a fluid flows, a resistor R that is provided within the flow path L and through which the fluid passes, a primary-side pressure sensor PO that is disposed in an outer surface of the block body B, a first pressure sensor P1, a second pressure sensor P2, an upstream-side fluid control valve V1, a downstream-side fluid control valve V2, and a control unit C that controls the upstream-side fluid control valve V1 and the downstream-side fluid control valve V2. Note that, in the following description, an upstream end of each flow path is called a base end, while a downstream end of each flow path is called a distal end.

As is shown in FIG. 1, the block body B has the flow path L, a primary-side connecting path PL0 that extends from the flow path L to the primary-side pressure sensor P0, an upstream-side connecting path PL1 that extends from the flow path L to the first pressure sensor P1, and a downstream-side connecting path PL2 that extends from the flow path L to the second pressure sensor P2. Furthermore, the block body B forms a portion of the flow path L, and additionally has a housing portion RS (i.e., a housing space) where the resistor R is housed. Note that the primary-side connecting path PL0, the upstream-side connecting path PL1, and the downstream-side connecting path PL2 each extend as branch flow paths from the flow path L.

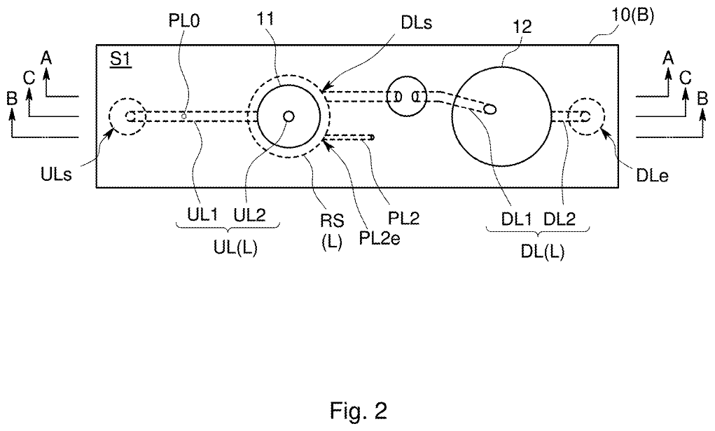

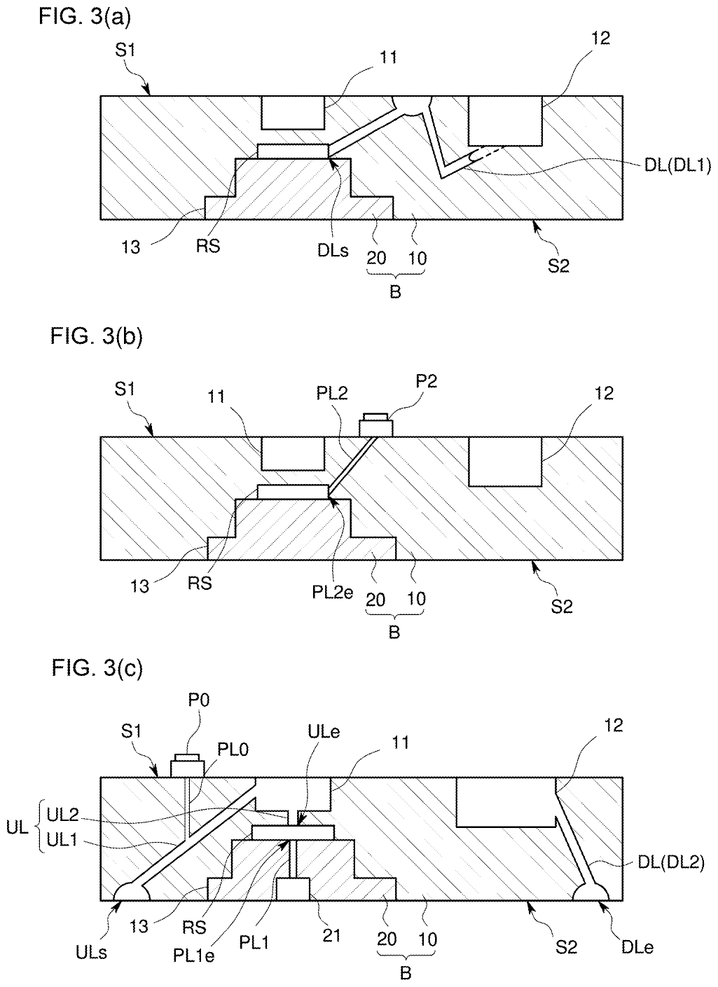

Moreover, as is shown in FIG. 3(c), an upstream-side flow path UL which forms an upstream side from the housing portion RS of the flow path L has a base end ULs that opens in an outer surface of the block body B, and a distal end ULe that is connected to the housing portion RS. Moreover, as is shown in FIG. 3(a) and FIG. 3(c), a downstream-side flow path DL which forms a downstream side from the housing portion RS of the flow path L has a base end DLs that is connected to the housing portion RS, and a distal end DLe that opens in an outer surface of the block body B. Note that, as is shown in FIG. 2, the downstream-side flow path DL and the downstream-side connecting path PL2 extend from the housing portion RS in parallel with each other when looked at in plan view. In other words, the downstream-side connecting path PL2 is connected to the housing portion RS at a separate position from the downstream-side flow path DL.

The primary-side connecting path PL0, the upstream-side connecting path PL1, and the downstream-side connecting path PL2 each have a smaller internal diameter than that of the flow path L. More specifically, the primary-side connecting path PL0 and the upstream-side connecting path PL1 have a smaller internal diameter than that of the upstream-side flow path UL. Furthermore, the downstream-side connecting path PL2 has a smaller internal diameter than that of the downstream-side flow path DL. Note that the internal diameters of each of the primary-side connecting path PL0, the upstream-side connecting path PL1, and the downstream-side connecting path PL2 are set, for example, to ϕ1˜2 mm.

As is shown in FIG. 1, the primary-side pressure sensor P0, the second pressure sensor P2, the upstream-side fluid control valve V1, and the downstream-side fluid control valve V2 are disposed on a predetermined surface S1 (in FIG. 1, this is the upper surface) in a first block body 10 of the present embodiment. More specifically, the first block body 10 has a first recessed portion 11 formed in the predetermined surface S1 thereof, and the upstream-side fluid control valve V1 is installed in this first recessed portion 11. The upstream-side flow path UL is divided into a first upstream-side flow path UL1 and a second upstream-side flow path UL2 by this first recessed portion 11. Note that the first upstream-side flow path UL1 is connected to a side surface of the first recessed portion 11, while the second upstream-side flow path UL2 is connected to a bottom surface of the first recessed portion 11. The first block body 10 additionally has a second recessed portion 12 formed in the predetermined surface S1 thereof, and the downstream-side fluid control valve V2 is installed in this second recessed portion 12. The downstream-side flow path DL is divided into a first downstream-side flow path DL1 and a second downstream-side flow path DL2 by this second recessed portion 12.

The overall shape of the block body B is formed in a substantially rectangular shape. More specifically, the block body B is provided with the substantially rectangular first block body 10, and with a second block body 20 that is fitted inside a third recessed portion 13 that is formed in an opposite surface S2 (in FIG. 1, this is the lower-side surface) from the predetermined surface S1 of the first block body 10. Consequently, a structure is created in which, as a result of the second block body 20 being fitted inside the third recessed portion 13 in the first block body 10, the housing portion RS is formed in the interior of the block body B. Note that, once the second block body 20 has been fitted inside the third recessed portion 13 in the first block body 10, the second block body 20 is fixed to the first block body 10 via screws or the like (not shown in the drawings). Moreover, the upstream-side flow path UL, the downstream-side flow path DL, the primary-ide connecting path PL0, and the downstream-side connecting path PL2 are provided within the first block body 10, while the upstream-side connecting path PL2 is provided within the second block body 20.

A fourth recessed portion 21 is provided in a surface of the second block body 20 that forms part of the opposite surface S2 from the predetermined surface S of the block body B. The first pressure sensor P1 is installed in this fourth recessed portion 21.

Looking at the overall block body B, the primary-side pressure sensor P0, the upstream-side fluid control valve V1, the second pressure sensor P2, and the downstream-side fluid control valve V2 are arranged on the predetermined surface S1 of the block body B in the above sequence from one-end side to the other-end side in the longitudinal direction thereof, while the first pressure sensor P1 is disposed in the opposite surface S2 from the predetermined surface S1. By employing this arrangement, it is possible to place each instrument making up the fluid control device MFC on the block body B with as little wasted space as possible.

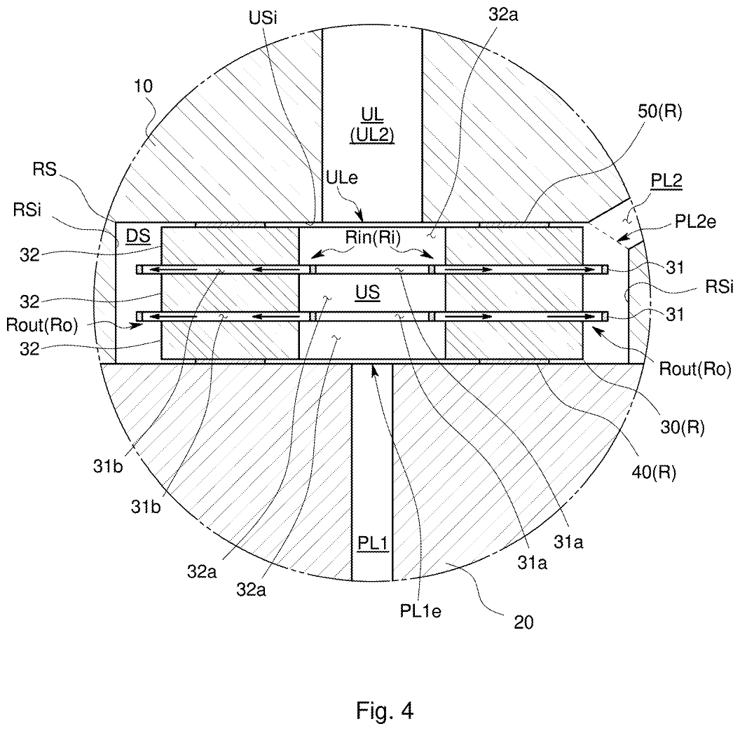

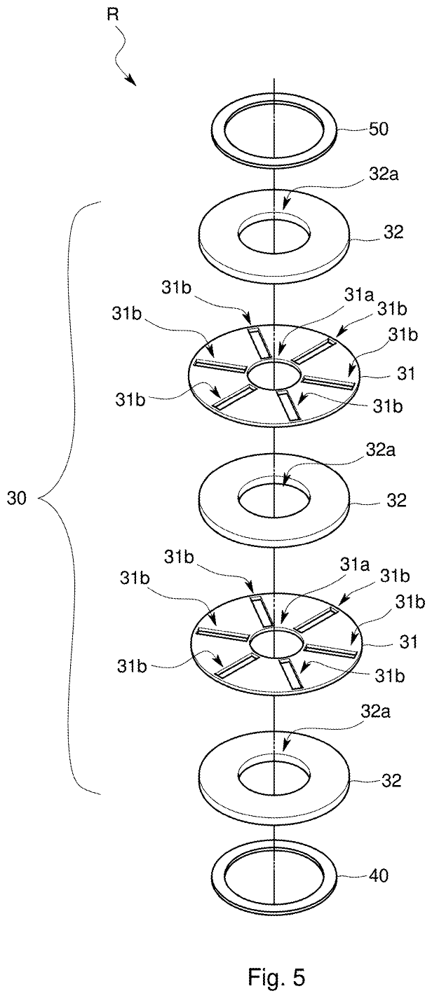

As is shown in FIG. 4 and FIG. 5, the resistor R is provided with a fluid resistance element 30 that is schematically formed in the shape of a rotating body, a first sealing component 40 that is interposed between the fluid resistance element 30 and the second block body 20, and a second sealing component 50 that is interposed between the fluid resistance element 30 and the first block body 10. Note that a fluid passes through the resistor R in a laminar flow state.

The fluid resistance element 30 has slit plates 31, and slit cover plates 32. The slit plates 31 each have a circular first through hole 31a that is formed so as to penetrate a central portion of the circular plate in a thickness direction thereof, and a plurality of slits 31b that are formed extending in a radial pattern from the aforementioned central portion. The slit cover plates 32 each have an outer diameter that is smaller than the outer diameter of the slit plates 31, and an inner diameter that is larger than the inner diameter of the slit plates 31, and a circular second through hole 32a that is formed so as to penetrate a central portion of the circular plate in a thickness direction thereof. In addition, the slit plates 31 and the slit cover plates 32 are stacked alternatingly on the second block body 20 so as to form a layered structure.

The resistor R is fixed in place by being sandwiched between the first block body 10 and the second bock body 20, in a state in which the first sealing component 40, the fluid resistance element 30, and the second sealing component 50 are stacked in this sequence on the second block body 20. As a result, the resistor R is installed inside the housing portion RS that is formed by the first block body 10 and the second block body 20.

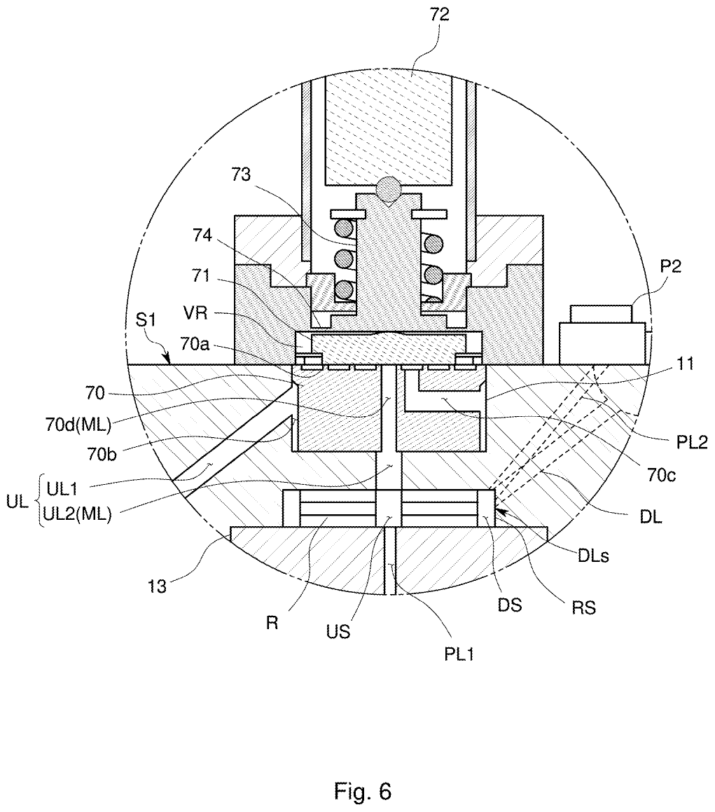

When the resistor R has been installed inside the housing space RS, the housing portion RS has the function of forming a partition between an upstream-side area US to which the distal end ULe of the upstream-side flow path UL is connected, and a downstream-side area DS to which the base end of the DLs (see FIG. 1, FIG. 2, FIG. 3(a), and FIG. 6) of the downstream-side flow path DL is connected. Note that the resistor R of the present embodiment is formed in an annular shape. Accordingly, the upstream-side area US is formed in a central portion (i.e., on the inside) of the resistor R, and the downstream-side area DS is formed so as to encircle an outer portion (i.e., an outer side) of the resistor R. In other words, the downstream-side area DS is formed between an inner-side surface RSi of the housing portion RS, and an outer-side surface Ro of the resistor R.

An inflow portion Rin that enables a fluid to be introduced is provided in the inner-side surface Ri forming part of the upstream-side area US of the resistor R, while an outflow portion Rout that enables a fluid to be discharged is provided in the outer-side surface Ro forming part of the downstream-side area DS thereof. Accordingly, the resistor R is formed such that, after a fluid has been introduced through the inflow portion Rin, this fluid passes through the slits 31b and is discharged to the outflow portion Rout.

Here, the above-described upstream-side flow area US is an area through which the fluid flows immediately prior to passing through the resistor R, in other words, immediately prior to being introduced into the resistor R. Moreover, the downstream-side flow area DS is an area through which the fluid flows immediately after having passed through the resistor R, in other words, immediately after having been discharged from the resistor R. In other words, the downstream-side area DS is an area through which a fluid flows in close to a laminar flow state.

The upstream-side connecting path PL1 is connected to the upstream-side area US of the housing portion RS, and connects this upstream-side area US to the first pressure sensor P1. A detection point of the first pressure sensor P1 on the flow path L is set to a location of a connection between the flow path L and the upstream-side area US (in the present embodiment, this is the location of the connection between the upstream-side area US and the upstream-side connecting path PL1). As a result, the detection point of the first pressure sensor P1 is set to a location which is comparatively close to the inflow portion Rin where a fluid is introduced into the resistor R, in other words, is set to a location which is a short distance (i.e., distance on the flow path) from the resistor R.

The downstream-side connecting path PL2 is connected to the downstream-side area DS of the housing portion RS, and connects this downstream-side area DS to the second pressure sensor P2. A detection point of the second pressure sensor P2 on the flow path L is set to a location of a connection between the flow path L and the downstream-side area DS (in the present embodiment, this is the location of the connection between the downstream-side area US and the downstream-side connecting path PL2). As a result, the detection point of the second pressure sensor P2 is set to a location which is comparatively close to the outflow portion Rout where a fluid is discharged from the resistor R, in other words, is set to a location which is a short distance (i.e., distance on the flow path) from the resistor R.

Accordingly, as is shown in FIG. 4, the housing portion RS includes the upstream-side area US where a fluid is introduced from the upstream-side flow path UL, and the downstream-side area DS where a fluid is discharged into the downstream-side flow path DL, and the resistor R is provided so as to form a partition between the upstream-side area US and the downstream-side area DS. In addition, in the housing portion RS, the distal end ULe of the upstream-side flow path UL and one end PL1e of the upstream-side connecting path PL1 each open in an inner surface USi forming part of the upstream-side area US, while the base end DLs of the downstream-side flow path DL and the one end PL2e of the downstream-side connecting path PL2 each open in an inner surface forming part of the downstream-side area DS.

Note that although the fluid discharged from the resistor R is substantially a laminar flow state immediately after being discharged from the resistor R, it progressively changes into a turbulent flow state as it travels towards the downstream side from that resistor R. However, by employing the structure described above, the second pressure sensor P2 is able to detect a pressure in a location which is only a short distance from the outflow portion Rout of the resistor R, and through which the fluid which has just been discharged from the resistor R and is still in a substantially laminar flow state is flowing. As a result, the second pressure sensor P2 is able to detect a pressure in a location through which a fluid that is still comparatively close to being in a laminar flow state is flowing, and if the flow rate of a fluid is calculated based on a theoretical formula using these detection values, then it is possible to reduce divergence between the actual flow rate and the calculated flow rate.

The above-described upstream-side fluid control valve V1 is what is known as a normal open-type valve. In addition, the upstream-side fluid control valve V1 is installed on the predetermined surface S1 of the block body B so as to fit inside the first recessed portion 11.

More specifically, as is shown in FIG. 6, the upstream-side fluid control valve V1 is provided with a valve seat component 70 that is fitted inside the first recessed portion 11 of the block body B, a valve body 71 that is installed so as to be able to move in directions towards and away from the valve seat component 70, an actuator 72 that causes the valve body 71 to move, a plunger 73 that is interposed between the valve body 71 and the actuator 72, and that transmits drive force from the actuator 72 to the valve body 71, and a thin-film shaped diaphragm 74 that is integrally connected to the plunger 73 and forms a portion of a valve chamber VR.

The valve seat component 70 is a block-shaped object that is fitted inside the first recessed portion 11 of the block body B. When the valve seat component 70 has been fitted inside the first recessed portion 11, a surface thereof that faces in the same direction as the predetermined surface S1 of the block body B is formed by a valve seat surface 70a. The valve chamber VR is formed in the upstream-side fluid control valve V1 between this valve seat surface 70a and the diaphragm 74, and the valve body 71 is housed within this valve chamber VR.

Moreover, an outer diameter of the valve seat component 70 which is on the valve seat surface 70a side thereof substantially matches an inner diameter of the first recessed portion 11, and an outer diameter of the valve seat component 70 on the opposite side from the valve seat surface 70a side is smaller than the inner diameter of the first recessed portion 11. As a result, by fitting the valve seat component 70 into the first recessed portion 11 of the block body B, a circumferential flow path 70b is formed between the valve seat component 70 and an inner circumferential surface of this first recessed portion 11. In addition, a first internal flow path 70c that connects the circumferential flow path 70b to the valve chamber VR is formed inside the valve seat component 70. Note that a distal end of the first internal flow path 70c opens in the valve seat surface 70a. Furthermore, a second internal flow path 70d that connects the valve chamber VR to the second upstream-side flow path UL2 is formed inside the valve seat component 70. Note that a base end of the second internal flow path 70d opens in a center of the valve seat surface 70a. The first upstream-side flow path UL1 is connected to the first recessed portion 11 so as to be in communication with the circumferential flow path 70b, and the second upstream-side flow path UL2 is connected to the first recessed portion 11 so as to be in communication with the second internal flow path 70d.

Here, the second internal flow path 70d from the valve chamber VR to the second upstream-side flow path UL2 extends in an orthogonal direction relative to the valve seat surface 70a, and so as to be coaxial with the second upstream-side flow path UL2. Additionally, the second upstream-side flow path UL2 extends coaxially with the upstream-side connecting path PL1. In other words, an intermediate flow path ML from the valve chamber VL to the upstream-side area US of the housing portion RS (in the present embodiment, this is a flow path formed from the second internal flow path 70d and the second upstream-side flow path UL2) is made to extend coaxially with the upstream-side connecting path PL1. As a result, a flow path from the valve chamber VR to the second pressure sensor P2 via the upstream-side area US provides communication in a straight line, so that the volume of this flow path is comparatively smaller.

The control unit C is connected to the primary-side pressure sensor P0, the first pressure sensor P1, the second pressure sensor P2, the upstream-side fluid control valve V1, and the downstream-side fluid control valve V2. Note that the control unit C is a computer which is provided with, for example, a CPU, memory, input/output devices, an A/D-D/A converter, and the like, and is formed so as to perform functions of a flow rate control unit, a primary-side pressure monitoring unit, and a valve opening/closing unit based on control programs that are stored in the memory.

The flow rate control unit controls a valve opening of the upstream-side fluid control valve V1 based on detection values from the first pressure sensor P1 and the second pressure sensor P2, and performs feedback control such that a flow rate of a fluid flowing through the upstream-side flow path UL approximates a set flow rate that has been set in advance. More specifically, the flow rate control unit calculates a flow rate based on a theoretical formula using detection values from the first pressure sensor P1 and detection values from the second pressure sensor P2, and controls the valve opening of the upstream-side fluid control valve V1 such that this calculated flow rate approximates the set flow rate.

The primary-side pressure monitoring unit monitors a primary-side pressure based on detection values from the primary-side pressure sensor P0. Note that, when the detection values from the primary-side pressure sensor P0 are outside a predetermined range, the primary-side pressure monitoring unit determines that the primary-side pressure is abnormal, and performs control of the valve opening of at least one of the upstream-side fluid control valve V1 and the downstream-side fluid control valve V2.

The valve opening/closing unit opens and closes the downstream-side fluid control valve V2 based on opening and closing signals input by a user, or on opening and closing signals received from the primary-side pressure monitoring unit.

### Additional Embodiment

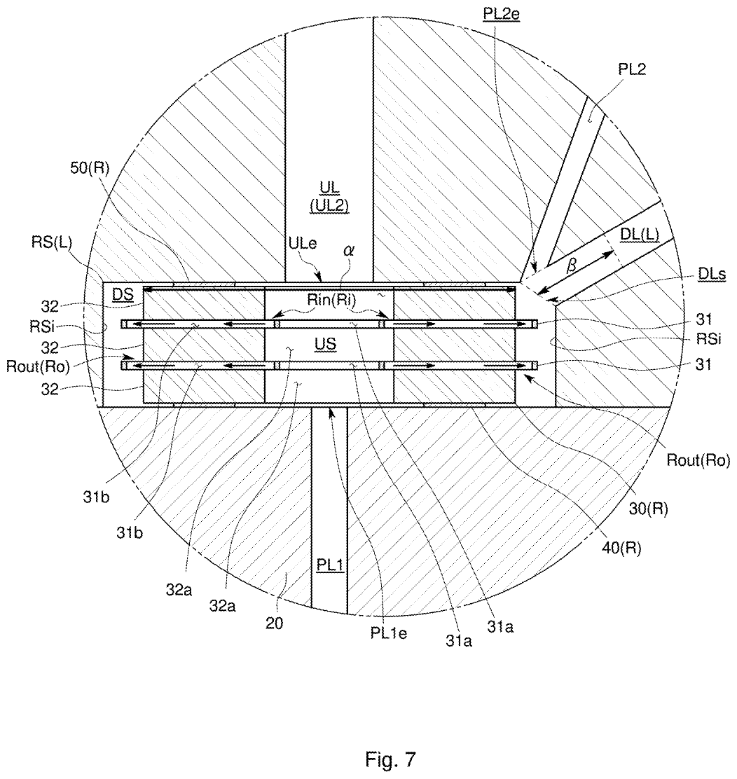

In the above-described embodiment, the downstream-side connecting path PL2 is formed so as to be connected to the downstream-side area DS of the housing portion RS, however, as is shown in FIG. 7, it is also possible for the downstream-side connecting path PL2 to be connected to a vicinity of the base end of the DLs of the downstream-side flow path DL that is connected to the downstream-side area DS of the housing portion RS. In other words, in the present embodiment, an end PL2e of the downstream-side connecting path PL2 opens in an inner surface in the vicinity of the base end DLs of the downstream-side flow path DL.

Here, the term ‘vicinity of the base end DLs’ refers to a distance range (shown by a symbol β in FIG. 7) whose one end is the base end DLs of the downstream-side flow path DL which opens in the inner surface of the downstream-side area DS of the housing portion RS, and whose other end is a position moved by a length of 60%, and more preferably of 50% of the outer diameter of the resistor R (shown by a symbol a in FIG. 7) towards the downstream side of the downstream-side flow path DL. More specifically, the one end of the distance range β is a center of an aperture of the base end DLs of the downstream-side flow path DL that opens in the inner surface of the downstream-side area DS of the housing portion RS. In other words, the one end of the distance range β is taken as a boundary between the downstream-side area DS of the housing portion RS and an area where the flow path L narrows from the downstream-side area DS (i.e., the portion of the base end DLs of the downstream-side flow path DL). Alternatively, the one end of the distance range β may be taken as a boundary between the downstream-side area DS of the housing portion RS and an area where pressure loss increases compared to the downstream-side area DS (i.e., the portion of the base end DLs of the downstream-side flow path DL). Furthermore, the term ‘outer diameter of the resistor R’ refers to an outer diameter of the slit cover plates 32. For example, if the outer diameter of the resistor R is 21 mm, then the distance range β is approximately 12 mm.

By employing this type of structure as well, by using the second pressure sensor P2, it is possible to detect a pressure of a fluid immediately after that fluid has been discharged from the resistor R, in other words, it is possible to detect a pressure in a location through which a fluid that is still comparatively close to being in a laminar flow state is flowing.

Moreover, in the above-described embodiment, the intermediate flow path ML is formed by a portion of the upstream-side flow path UL (i.e., the second upstream-side flow path UL2), and a portion of the internal flow path in the valve seat component 70 (i.e., the second internal flow path 70d), however, the intermediate flow path ML may also be formed solely by the portion of the internal flow path in the valve seat component 70 (i.e., the second internal flow path 70d). In this case, a structure may be employed in which the valve seat component 70 forms a portion of the housing portion RS. If this type of structure is employed, then the internal volume of the intermediate flow path ML can be reduced even further, and the length of the intermediate flow path ML can also be further shortened.

Moreover, in the above-described embodiment, a fluid control valve is connected to both the upstream-side flow path UL and the downstream-side flow path DL, however, it is also possible for only one fluid control valve to be connected to either the upstream-side flow path UL or the downstream-side flow path DL. Moreover, in the above-described embodiment, the flow rate of a fluid is controlled by the downstream-side fluid control valve V2, while the pressure of a fluid is controlled by the upstream-side fluid control valve V1, however, the present invention is not limited to this. For example, it is also possible for the flow rate of a fluid to be controlled by the upstream-side fluid control valve V1.

Furthermore, it should be understood that the present invention is not limited to the above-described embodiments, and that various modifications and the like may be made thereto insofar as they do not depart from the spirit or scope of the present invention.

### DESCRIPTION OF THE REFERENCE CHARACTERS

MFC . . . Fluid Control Device

B . . . Block Body

UL . . . Upstream-side Flow Path

ULe . . . Distal End

DL . . . Downstream-side Flow Path

DLs . . . Base End

PL1 . . . Upstream-side Connecting Path

PL2 . . . Downstream-side Connecting Path

ML . . . Intermediate Flow Path

RS . . . Housing Portion

US . . . Upstream-side Area

DS . . . Downstream-side Area

P1 . . . First Pressure Sensor

P2 . . . Second Pressure Sensor

V1 . . . Upstream-side Fluid Control Valve

V2 . . . Downstream-side Fluid Control Valve

R . . . Resistor

What is claimed is:

1. A fluid control device comprising:
a block body having an internal flow path through which a fluid flows;
a resistor that is provided within the flow path and through which the fluid passes;
a first pressure sensor that detects a pressure on an upstream side of the resistor;
a second pressure sensor that detects a pressure on a downstream side of the resistor; and
a fluid control valve that controls the fluid based on detection values from the first pressure sensor and the second pressure sensor, wherein
the block body further comprises an internal housing portion that forms a portion of the flow path and that houses the resistor, and
a downstream-side flow path which forms the downstream side of the flow path from the housing portion has a base end that is connected to a downstream-side area through which flows the fluid that has already passed through the resistor in the housing portion, and
the second pressure sensor is connected to the downstream-side area of the housing portion or to a vicinity of the base end of the downstream-side flow path.

2. The fluid control device according to claim 1, wherein the block body additionally comprises an internal downstream-side connecting path that is connected to the downstream-side area of the housing portion or to the vicinity of the base end of the downstream-side flow path, and that has a smaller internal diameter than that of the downstream-side flow path, and
the second pressure sensor is connected via the downstream-side connecting path to the downstream-side area of the housing portion or to the vicinity of the base end of the downstream-side flow path.

3. The fluid control device according to claim 1, wherein an upstream-side flow path which forms the upstream side of the flow path from the housing portion has a distal end that is connected to an upstream-side area through which the fluid flows prior to passing through the resistor in the housing portion, and
the first pressure sensor is connected to the upstream-side area of the housing portion or to a vicinity of the distal end of the upstream-side flow path.

4. The fluid control device according to claim 3, wherein the block body additionally comprises an internal upstream-side connecting path that is connected to the upstream-side area of the housing portion or to the vicinity of the distal end of the upstream-side flow path, and that has a smaller internal diameter than that of the upstream-side flow path, and
the first pressure sensor is connected via the upstream-side connecting path to the upstream-side area of the housing portion or to the vicinity of the distal end of the upstream-side flow path.

5. The fluid control device according to claim 3, wherein
the fluid control valve is disposed on a predetermined surface of the block body, and
an intermediate flow path from a valve chamber of the fluid control valve to the upstream-side area of the housing portion extends in an orthogonal direction relative to a valve seat surface of the fluid control valve.

6. The fluid control device according to claim 5, wherein
the first pressure sensor is disposed in an opposite surface from the predetermined surface of the block body, and
the upstream-side connecting path extends coaxially with the intermediate flow path.

5. The fluid control device according to claim 5, wherein
the intermediate flow path communicates with the upstream-side area through an internal flow path extending from the valve chamber of the fluid control valve.
